(19) United States
(12) Patent Application Publication
(10) Pub. No.: US 2026/0259551 A1
(43) Pub. Date: Sep. 3, 2026

(54) END-TO-END PLANNING AND INTERVENTION SYSTEM

(71) Applicants: REALKOM TEKSTIL URUNLERI SANAYI PAZARLAMA VE DIS TICARET ANONIM SIRKETI, Eyup, Istanbul (TR); REAL SOLUTIONS BILISIM TEKNOLOJILERI SANAYI TICARET ANONIM SIRKETI, Merkez, Duzce (TR)

(72) Inventors: Bisar ALPAGUT, Merkez, Duzce (TR); Furkan UNGOREN, Umraniye, Istanbul (TR)

(21) Appl. No.: 19/163,631

(22) PCT Filed: Mar. 8, 2024
(86) PCT No.: PCT/TR2024/050233

§ 371 Date: Sep. 9, 2025

(30) Foreign Application Priority Data
Mar. 9, 2023 (TR) 2023/002608

(51) Int. Cl. G05B 19/418; G06Q 10/0631

(52) U.S. Cl. CPC G05B 19/41865; G05B 19/41875; G06Q 10/06316; G05B 2219/32365; G05B 2219/34418

(57) ABSTRACT

The present invention is an integrated electronic system designed for real time planning and management of any or complete production processes, from storage to shipping, in the textile industry. The system utilizes data from production machinery and equipment, enabling real time planning and intervention. Key components comprise various production departments (storage, modeling, cutting, sewing, washing, ironing-packaging, shipping departments), machinery for process management, a decision engine for real time data interpretation and work order distribution, and a server facilitating data exchange via wireless or wired communication. This end-to-end management system streamlines production by allowing instant updates and modifications, thereby improving efficiency and adaptability in textile manufacturing operations.

### TECHNICAL FIELD

The invention relates to a system which is configured for planning of the production in the readymade clothing industry, monitoring production stages in real time and intervening in real time to problems that may arise during production, and to a method that enables the operation of the system. The main characteristic of the invention is that it is an integrated electronic system which monitors the production operations carried out in all production departments, including warehouse, design, cutting, sewing, washing (recipe), ironing-packaging and shipping departments, in real time, and directs all said operations via visual and auditory warning systems and performs quality and efficiency analysis at every stage and then automatically reports them.

### PRIOR ART

The increasing human population in today's world and the increase in the level of prosperity on a global scale, especially in the 21st century, have increased the demand for consumption all over the world. The increase in consumption demand has also affected production processes. Particularly the sectors that perform mass production (especially raw material production), which allows the production tools to become autonomous, have structured themselves according to this new situation. Standardization of production processes has become necessary because of the increase in demand for these sectors, where production is carried out mainly by machinery. However, in the readymade clothing industry, which is a branch of the textile industry, the constant change in demand for product types (especially due to the influence of fashion) and the dependence of production quantities on order quantities prevent the structuring of production operations on a machine-based basis. It is seen that a method has been adopted in the readymade clothing industry, where the products of different types, shapes and numbers are mainly transferred to different production lines (for example, workshops). In other words, an established order has emerged in the form of distribution of raw materials (fabric) and collection of products. Apart from this mentioned method, it is also possible to produce different types, shapes and numbers of products on the same production line. However, this situation causes the development of a production mechanism based on human experience (and therefore based on the number and experience of people) instead of mechanization and causes increases in errors that occur in the production processes. In addition, constantly producing different types and shapes of products negatively affects employees' ability to reach sufficient experience. As in all sectors, it is seen that various systems in which machinery is predominant have been developed in the readymade clothing industry, instead of production organizations based on manpower and experience, for purposes such as preventing human-induced errors, uniformizing production and minimizing energy and time loss by achieving high production quantities in a short time.

In the state of the art, there are various systems in which production processes are free from human intervention and almost all production processes are carried out by machines controlled by software. However, these systems generally give successful results when it is desired to produce uniform products (for example, producing a fabric, producing a canned food, etc.). Considering the readymade clothing industry, where the type of products to be produced constantly changes depending on the order, it can be said that 100% success has not been achieved in the application of similar approaches.

In the readymade clothing industry, the ongoing processes of a manufactured product, from raw material to final product, necessitate various independent operations. For example, it is possible to carry out the processes from producing the fabric used as raw material (raw fabric), then dyeing it and making it ready for cutting by going through various processes-mentioned above-with mass production methods. To reiterate, in the readymade clothing industry, fabric production, dyeing, etc., it is seen that there are monitoring and guidance systems in which the stages are automatically controlled and various instructions are given to the employees. However, the same situation is not valid for readymade clothing operations, where the production quantity and the product model to be produced, which we can simply express in four stages as fabric cutting, sewing, washing and ironing-packaging, constantly change. The reason for this is that, operations such as cutting and sewing depend on customer demands, unlike operations such as yarn production, fabric production from yarn or dyeing of fabrics. More clearly, the quantity of an order may change instantly, and design changes may be requested in a produced model. According to such instant decision changes, all operations need to be revised according to the new situation. This necessitates stopping production operations and making a new production plan according to the new situation.

In the prior art, various enterprise resource planning (ERP) systems used in the readymade clothing industry are encountered. ERP systems offer various opportunities for businesses in terms of digitalization and reporting, such as effective use of business resources, ensuring common and efficient use of resources, flexible product configuration and effective stock management. These systems direct administrative processes and production stages in the light of data entered into the system by people. In other words, the said systems do not have the ability to manage production processes without the need for human intervention. The continuity of said systems depends on the staff involved in the production processes entering the data they obtain into spreadsheet programs such as Microsoft Excel. The said data, whose accuracy cannot be questioned in real time, can mislead ERP systems, which results in the analysis made by the system being inaccurate. The fact that system continuity is based on data entries made by humans emerges as a deficiency. In this context, failure to enter data into the system or entering incorrect data will cause the reports generated by the system to be incomplete or incorrect. For this reason, the success of the system depends on the abilities of the human resources using the system.

In the prior art, the invention disclosed in the Chinese Patent No. CN209297153U is generally related to an automatic tracking system that produces the real time data, using RFID (Radio Frequency Identification) technology in the textile industry. The system includes a monitoring center, a remote server, a database server and a first communication module and a plurality of production terminals associated with them. Each terminal corresponds to one weaving machine. Each collection terminal includes a display unit, an RFID unit, a second communication module and a signal acquisition and processing unit. The signal acquisition and processing unit is a single chip controller. The processor is a personal computer. The first communication module and the second communication module are both wireless communication modules. The invention is a production tracking system used only to receive data from weaving looms. There is no information here about how the invention can be used in different production departments or how the data is received and processed.

In the prior art, the invention disclosed in the US Patent No. US2021271224A1 is an automation system developed for the textile industry, in general outline. The invention is characterized by a monitoring and pre-warning system consisting of multiple detection devices contacted with the textile equipment of the invention to detect simultaneous status information of said equipment. All production processes occurring during operation in the system are expressed as status information. The time when these data obtained is described as real time state. The monitoring system allowing the collection of real time status information consists of subsystems. These subsystems can be listed as data collection monitoring system, a remote office system, a production control system, a weaving command information system, a production preparation order monitoring system, a twist monitoring system, a dyeing monitoring system, a water quality monitoring system and a quality monitoring management system. These systems can also be described as modules. The pre-warning and integrated system is a central information system that analyzes real time status information on the host computer. This system consists of a cloud database, at least one end device, and display devices that allow to get real time status information and to display analytical data. Although the invention is described as a cloud integrated system that integrates all processes in a textile factory into a central information integration system, it only tracks the data of the dyeing, recycling, waste and quality departments. The invention enables remote monitoring of production processes and remote intervention in case of any malfunction. However, here the problem is that the intervention system is not available in all departments and the persons who manage the system make decisions, not the system itself. The system does not able to start or stop the machines in the facility without human intervention. For example, according to an order, a washing department does not able to determine all washing data such as temperature settings, amount of chemicals and water and number of cycles automatically and activate them. The system is constantly dependent on human intervention.

Chinese patent no. CN106056298A discloses, in general terms, an automation system developed for the textile industry. The invention relates to a planning and tracking system that allows real time planning of work in a factory or workshop. Here, the invention is characterized by warehouse hardware installation performed by a robot, monitoring of said equipment during operation, and detection of errors. The invention is a system developed only for warehouse operations.

Chinese patent no. CN111369103A discloses an enterprise resource planning (ERP) system developed for the textile industry. The system can be monitored by at least one user (customer) via the cloud server. Said cloud server includes at least one core (kernel) controller used to manage each module resource of the system. Said controller is used to set up numerous service units for the business module, production, sales, finance, data and systems. It is seen that the invention No: CN111369103A and similar ERP systems are generally managed on the basis of the end-of-day data entries of administrative processes and production stages. In this context, staff report their field work by entering data into physical forms or Microsoft Excel tables. Data collected through these and similar methods are entered into ERP systems as data at the end of the day. Thus, the system can only perform reporting operations after making data entries. In this context, about the operations, digitalization and reporting opportunities about the operations, such as effective use of business resources in ERP systems, ensuring common and efficient use of resources, ensuring flexible product configuration, ensuring effective stock management is provided. The fact that all these processes are based on data entry by staff will cause the system to fail if any staff does not enter data or makes incorrect data entries. In addition, the fact that the system makes reporting after the processes are completed (at the end of the day), makes it impossible for intervention of instant production errors via the system.

U.S. Pat. No. 11,080,576B2 is related to a system that allows automatic scanning and tracking of each of the textile products produced via an RFID tag. In the system of the invention, there is a receiving (warehouse) station, sorting station, washing station, drying station, folding station, shipping station terminals and an RFID reader connected to each terminal. In particular, the features of the RFID reader located in the drying station (location, etc.) are discussed in detail. In order to track the products, each product must have a tag with RFID technology. In the invention, improvements for drying operations are generally discussed. In the absence of said tag, it is unclear how the system will carry out the tracking process. Management of the production processes in cutting, sewing, ironing-packaging and washing departments, where very different operations are performed, are out of scope of how the system will intervene in case of a malfunction in said production processes.

In the prior art, available systems can contact with the machines used in production stages, receive data and send instructions to the machines via human intervention. However, systems related to cutting, sewing, washing and ironing-packaging operations make reports to managers according to the data entered into the system by employees, and production processes require constant intervention by authorized persons. In the readymade clothing industry, there is no system that plans, manages and reports production processes in real time, from the warehouse stage to the shipping stage, without the need for human intervention, and makes suggestions to managers.

In the prior art, in the production departments of the readymade clothing industry, it is seen that a machine-controlled system is needed, wherein said system is
able to plan by revising all production processes in real time according to changes in production operations,
able to manage employees or machines in real time according to the progress of the work (for example, cancellation of an order, requests for instant design changes in the order, etc.),
able to automatically create work orders, calculate the average completion time of a job, and create work orders and status reports in real time,
able to make result predictions regarding production processes (in the base of the past data recorded in the database) and make efficiency and quality measurements as real time at every stage of production.

### TECHNICAL PROBLEMS ADDRESSED BY THE INVENTION

The present invention was developed for use in the readymade clothing industry to solve the problems in the state of the art, discussed in the previous section. The invention relates to an electronic system that plans, controls and monitors all real time production processes, carried out from acceptance of the product order to product shipping, in the readymade clothing industry and intervenes the errors that occur in the production processes, in real time and a method that allows the system to operate. The invention in real time aims to create an electronic end-to-end management system that monitors all production departments via cameras and sensors, can receive data from the equipment positioned in these departments and then send instructions to the relevant equipment, and can manage the staff who operate in said departments via visual and auditory warning systems. The end-to-end management system is characterized in that it can detect all measurable operations via all machines and equipment in the work area and then stop the relevant operation instantly (in real time), replan it and manage it through warning mechanisms. Thanks to this characteristic, instant problems that arise in production processes can be solved-without the need for human intervention.

An advantage of the invention is that it is a machine controlled system that is
able to plan by revising all production processes in real time according to changes in production operations, to manage employees or machines in real time according to the progress of the work (for example, cancellation of an order, requests for instant design changes in the order, etc.),
able to automatically create work orders, calculate the average completion time of a job, and create work orders and status reports in real time,
able to make result predictions regarding production processes (in the base of the past data recorded in the database) and to make efficiency and quality measurements at every stage of production.

Another advantage of the invention is that the modules therein eliminate the need for end-of-day data entry in stock tracking by collecting instant data from the field. While the system collects data from the field, it works by integrating with electronic cards as well as it can receive data from all electronic devices and Industrial Automation devices (PLC, HMI, Controller, Smart Relay, Communication Cards) used in the field by using the infrastructures of communication protocols (MODBUS, Profinet, CanBus, Wifi, TCP/IP, RS232/485, etc.)., and report data instantly. Thanks to the system, production processes are instantly recorded in the system, independent of the working staff. In this way, labor loss caused by data entry is eliminated. However, in the systems in the state of the art and are related to cutting, sewing, washing and ironing-packaging departments, data are not entered instantly, but are entered into the system after the operations are completed (end of day data). This causes these systems to be ineffective in solving a problem that occurs instantly.

Another advantage of the invention is that it eliminates the workload brought by ERP systems with end-of-day data in the state of the art. All modules in the system subject to the invention collect data by communicating instantly with the devices in the field. In addition to these, the machines that the staff want to operate based on their authorization can be determined through the system and the staff labor force participation rate can be calculated instantly.

Another advantage of the invention is that it controls all operational processes such as equipment numbers (band numbers, etc.), operation names, operation times, staff information working on the band, and sewing data through the electronic equipment and can receive data from the field in real time. In addition, the signal data received from the smartcards of all staff working in a department are matched in real time with the detected locations and all machinery and equipment in the production departments. In this way, staff and department efficiency is calculated in real time, integrated with the hardware, and without the need for human intervention.

Another advantage of the invention is that it has the feature of creating separate error and analysis reports for the number of machines, equipment and staff in production, the production amount, the current locations of said machines, equipment and staff in the production areas, and errors detected in real time.

For example, when an error occurs in any department, an error report is sent to the decision engine by the module controlling the relevant department (for example, when an error report is sent by the recipe module). It compares the error report sent to the decision engine with the past error data recorded in the database and then sends an instruction to the relevant module to continue or stop the process. Accordingly, if the error made is within acceptable error limits, the products are sent to the next stage. On the contrary, if the error made is not within the error limits, the process is terminated at that stage and a report is generated indicating whether the operations should be carried out from the beginning or, alternatively, which steps should be followed. Thus, the decision engine can make management decisions regarding the continuation or stopping of the stages of the production process without any human intervention. The decision engine instantly measures the work efficiency of the facility by using all the data obtained during the production processes (error reports, working hours, quantities of products produced, production time, total amount of defective products, etc.).

An advantage of the invention is that, through the decision engine, it can automatically disable the machines by measuring whether there is a difference between the commands given during operation and the application of the staff. For example, if a staff working in the cutting department accidentally tries to spread a different fabric, the machine will be automatically stopped by the system and the system will automatically send warning e-mails regarding this error.

An advantage of the invention is that since the real time matching of the data obtained from the smartcards and/or smart wristbands carried by the staff with the data received from the cameras, sensors and other machines in the production departments, the time when the staff enters and leaves work and the work done during this period can be tracked and salary calculations are made automatically.

Another advantage of the invention is that all production departments are operated according to data determined by the system. Here, predetermined data is sent to the machines in the production departments, allowing the machines in question to start or stop automatically. The data, for example, for the washing department, the amount of chemical to be used in washing, the duration of the washing process, the temperature value of the water to be used in washing, etc. is determined automatically by the system without the need for human intervention.

Another advantage of the invention is the ability to give work descriptions to employees regarding the transactions which they perform in real time, through electronic screens containing microphones and speakers located in each department and managed by the system. In this way, errors made by inexperienced employees in production are minimized. In addition, if the system subject to the invention detects a problem at any stage of production, it can intervene in production in real time with speakers and graphical warnings (warning signs appearing on the screen, etc.) on electronic screens. For example, information such as the order in which the fabrics coming from the warehouse department to the cutting department will be spread, what technical details should be paid attention to regarding the fabric, are notified to the operators (staff) as visual and voice commands.

Another advantage of the invention is that it can instantly monitor the quality status from the field with the help of handheld terminals, cameras and sensors, and create automatic reports containing information such as where the error occurred, what caused it, at what stage the error could have been compensated (in which workshop the problem occurred, etc.).

Another advantage of the invention is that all the processes that a produced product goes through, from the warehouse stage to the shipping stage, are addressed and recorded in the database. In this way, it is possible to determine which product was damaged at which production stage and due to which error, in terms of location, time, and responsible department.

Another advantage of the invention is that if the product does not have the desired features during production (non-desirable width dimensions, quality errors, etc.), then the error report system can be activated and automatically report the action that needs to be taken to the managers. For example, it has suggestion and decision mechanisms such as not proceeding to the next stage, actions to be taken in the next stage, etc.

The following figures will be used for better understanding of the system of the invention.

### BRIEF DESCRIPTION OF FIGURES

FIG. 1 is a conceptual design drawing illustrating the main elements that constitute the end-to-end management system according to the invention.

FIG. 2 is a diagram illustrating the modules included in the management program of the end-to-end management system according to the invention and their relationship with the management panel.

FIG. 3 illustrates a conceptual design of the human and machine elements located in the warehouse department, and managed and directed by the management program, within the end-to-end management system according to the invention.

FIG. 4 illustrates a conceptual design of the human and machine elements located in the design department, and managed and directed by the management program, within the end-to-end management system according to the invention.

FIG. 5 illustrates a conceptual design of the human and machine elements located in the cutting department, and managed and directed by the management program, within the end-to-end management system according to the invention.

FIG. 6 illustrates a conceptual design of the human and machine elements located in the sewing department, and managed and directed by the management program, within the end-to-end management system according to the invention.

FIG. 7 illustrates a conceptual design of the human and machine elements located in the washing department, and managed and directed by the management program, within the end-to-end management system according to the invention.

FIG. 8 illustrates a conceptual design of the human and machine elements located in the ironing-packaging department, and managed and directed by the management program, within the end-to-end management system according to the invention.

FIG. 9 illustrates a conceptual design of the human and machine elements located in the shipping department, and managed and directed by the management program, within the end-to-end management system according to the invention.

FIG. 10 is a flowchart illustrating real time data exchange and real time directive of the elements, as the core operations included in the end-to-end management system according to the invention.

FIG. 11 is a flowchart illustrating the core operations of the end-to-end management system according to the invention.

### Reference Numbers Corresponding to the Names of Process Stages, Departments, and Parts in the Figures

1—End-to-end management system
2—Management program
3—Management panel
   3a—Manager interface
   3b—Customer interface
   3c—Staff interface
4—Decision engine
   4a—Warehouse module
   4b—Design department module
   4c—Cutting department module
   4d—Sewing department module
   4e—Recipe module
   4f—Ironing-packaging department module
   4g—Shipping department module
5—Server
6—Database
7—Camera
8—Sensor
9—Smartcard
10—Smart wristband
11—Handheld terminal
12—Electronic display
13—Roll of fabric
   13a—Sample fabric
14—Cut model
15—Sewn model
16—Label
17—Product box
18—Warehouse department
   18a—Warehouse staff
19—Design department
   19a—Design staff
   19b—Plotting machine (Plotter)
20—Cutting department
   20a—cutting department staff
   20b—Cutting table
   20c—Spreading machine
   20d—Automatic cutting machine
   20e—Semi-automatic cutting machine
   20f—Labeling machine
21—Sewing department
   21a—Sewing staff
   21b—Sewing machine
22—Washing department
   22a—Washing staff
   22b—Washing machine
23—Ironing and packaging department
   23a—Ironing and packaging staff
   23b—Ironing table
24—Shipping department
   24a—Shipping staff
   24b—Carrier
   24c—Shipping vehicle
25—Modem
26—Wireless connection system
50—Positioning of fixed system hardware in production departments
51—Association of mobile system hardware with production machines
52—Data collection from production departments
53—Sending work orders to production departments
A—Planning, monitoring, and reporting process
101—General management stage of the warehouse department
102—General management stage of the design department
103—General management stage of the cutting department
104—General management stage of the sewing department
105—General management stage of the washing department
106—General management stage of the Ironing-Packaging Department
107—General management stage of the Shipping department

### DETAILED DESCRIPTION OF THE INVENTION

The present invention generally seeks to establish an integrated electronic system and a method enabling the operation of such a system, which allows for planning, monitoring, directing and intervening in real time by machines in the production processes conducted from the warehouse department to the shipping department in the readymade clothing industry, as well as allowing for correction of any errors in real time that may arise during these production processes, all without the need for human intervention. Specifically, the invention targets an end-to-end management system that allows for the real time planning, monitoring, directing, and intervention of production processes, and allowing for correction of any errors in real time that may arise during any of these processes, based on data collected from all machinery and equipment used in these processes, in conjunction with cameras, sensors, smartcards, and smart wristbands, deployed across each production department, thereby eliminating the need for human involvement.

While the invention is primarily related to the planning, production, and monitoring processes within the warehouse, design, cutting, sewing, washing, ironing-packaging, and shipping departments in the readymade clothing industry, it is also applicable and usable across various other sectors and production fields where the system can conveniently be integrated.

Hereinafter, the invention will be described in detail by referring drawings; however, since there may occur potential modifications to the design, size, or layout, it is important to note that the drawings should not be seen as restrictive for the scope of the invention, and the entire system is of the subject of the protection. The description does not detail every piece of machinery and equipment located within the production departments associated with the system according to the invention. For example, in the warehouse department, while devices like scales for fabric weighing, machinery for fabric transport (such as forklifts), and storage solutions like pallets or shelves will indeed exist, there exists no need to enumerate and mention such machines and equipment (already existing in the prior art) since they are not directly related to the core system of the invention.

The end-to-end management system (1) of the invention includes a set of common features used for different purposes in each department. Said features are labels (16), cameras (7), sensors (8), smartcards (9), smart wristbands (10), handheld terminals (11), and electronic displays (12). Said label (16) is a material that can be read by a scanning device, featuring a barcode, a sequence of numbers, or a QR code, and identifies the characteristics of the product on which it is affixed or sewn. Depending on the area of use, its material structure and geometric shape may vary. Said camera (7) preferably rotates 360 degrees and has the capability to transfer the visual data it obtains to another device or system via a built-in Wi-Fi adapter or an embedded SIM chip (electronic SIM) of the wireless connection system (26) which are located within the machinery and equipment. Said sensor (8) is a device capable of recognizing distance (capacitive, inductive, infrared optical, etc.), temperature (NTC), sound (dynamic, capacitive, etc.), or color (LDR, RGB, UV, etc.) depending on the production department in which it is used. Said smartcard (9) is a card equipped with RFID (Radio Frequency Identification) or NFC (Near Field Communication) technology. Said smart wristband (10) is a device with an integrated location tracking device, wearable on the human wrist (GPS wristband, smartwatch, etc.). Said electronic display (12) is an electronic device that allows people to watch images, such as LCD, AMOLED, plasma, etc. Said electronic display (12) is a type of imaging device containing a speaker and a microphone, thereby collecting sound data from its surroundings through the microphone. Its graphic screen allows sharing work descriptions, work status information, and warning graphics. It is also used for making warnings in emergencies or providing work descriptions through its built-in speaker. The server (5) included in the end-to-end management system (1) is a server computer according to one embodiment of invention. In this case, the database (6) is hosted inside the computer. In another embodiment of the invention, the server (5) is a device like a personal computer or smartphone that does not host the database (6) internally. In this case, a connection will be established with the database (6) via cloud computing. There is at least one modem (25) in each production department.

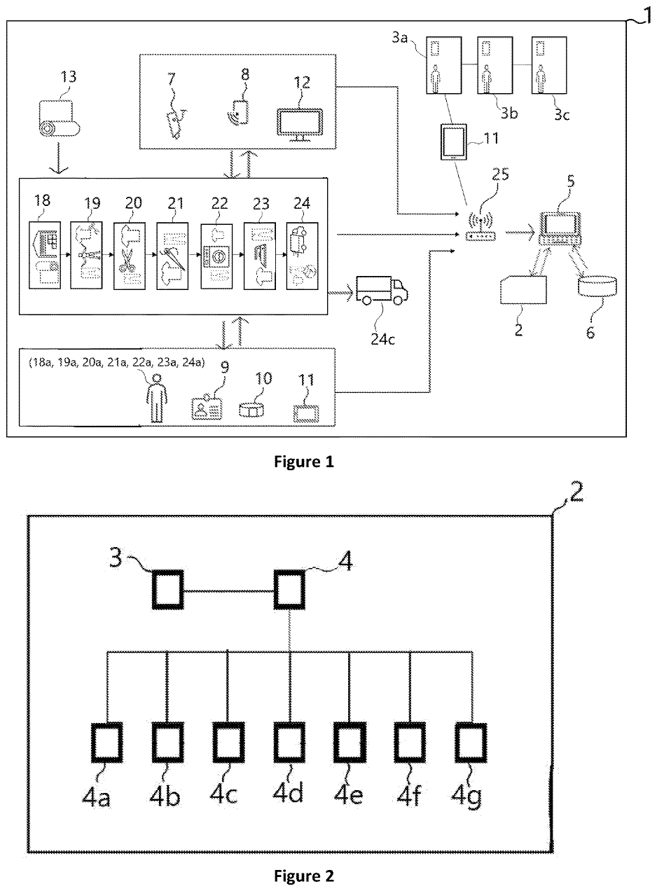

The end-to-end management system according to the invention (1), a conceptual design of which illustrated in FIG. 1, is an electronic management system that can be applied to one, several, or all production departments of the readymade clothing industry, namely the warehouse department (18), design department (19), cutting department (20), sewing department (21), washing department (22), ironing-packaging (23) department, and shipping department (24). This system manages the work processes in the relevant production departments by receiving and sending data from and to the machinery and equipment involved in production. The data exchange between machinery and equipment in said production departments is carried out by conventional approaches of existing technologies, preferably using the Internet of Things (IoT) technology, preferably wirelessly (Wifi, Wimax, Zigbee, Bluetooth, infrared, etc.) or through wired connections (fiber optic, EtherCat, coaxial cables). Said data are interpreted by the machine learning-based algorithm of the system, transforming them into output data that allow the management of all connected machinery and equipment. Thus, the system can broadly be defined as an electronic system that receives data from and sends data to the connected machines and equipment, and thus controlling and directing said components. However, in order to clarify how this system stands apart from existing ERP systems in the readymade clothing industry, which conduct comparable tasks, or from other systems that manage production in real time without human intervention, an illustrative application of the system according to the invention will be described below. For this purpose, a readymade clothing production facility managed by the system of the invention has been taken as an example. An explanation will be provided on how the system manages and tracks an order of “N” number of products within the framework of the end-to-end management system (1). In said application of the invention, data is sent to the server (5) from each department via a modem (25) located in that department, utilizing either wired or wireless connections to the internet network. Furthermore, the system can also communicate with the server (5) over the internet using other IoT communication hardware (such as eSIM). The management program (2) housed in the server (5) analyses and interprets all data obtained throughout the production process simultaneously, executing functions such as planning of production, monitoring/tracking of production activities, and real time intervention in the production process.

Since the methodology for collecting data in the production departments leading up to the cutting department (20) (utilizing cameras (7), sensors (8), smartcards (9), etc.) is identical to that in the subsequent production departments (such as the sewing department (21), washing department (22), etc.), it was deemed unnecessary to detail the later stages. This restriction is specific to the exemplary application outlined below. The operations across all production departments will be broadly covered later in subsequent departments of the detailed description. An illustrative scenario demonstrating how the planning, production, monitoring, and real time intervention functions for an order of N products are executed within the end-to-end management system (1) will thus be detailed below.

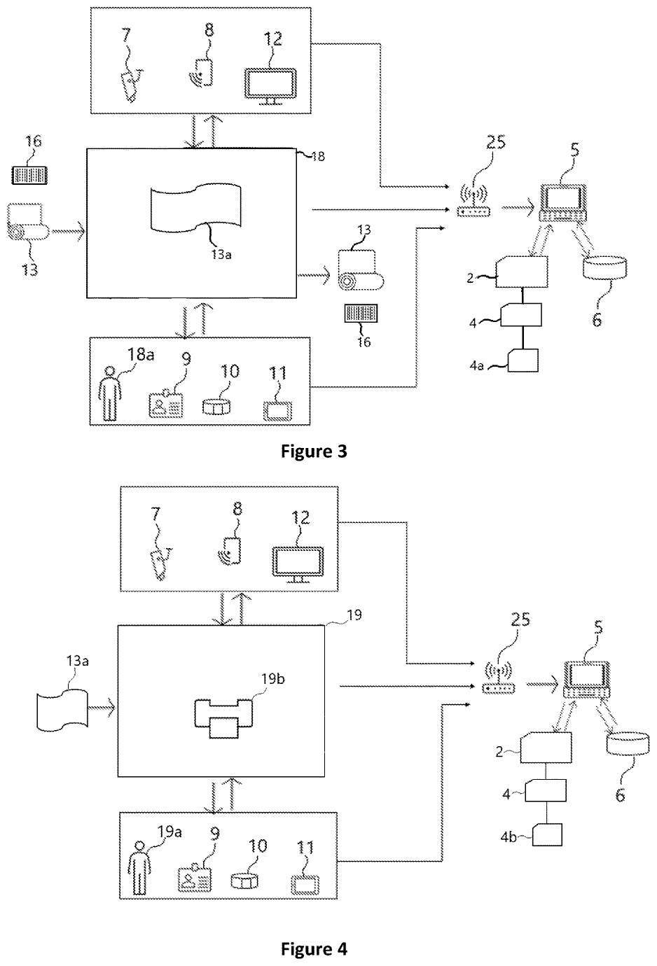

With the end-to-end management system (1) according to the invention, data such as the product design (model) for an order of “N” units, types and weights of fabrics to be used, size distributions according to the design (model), and the number of pieces to be produced per size are entered into the management program (2). This entry can preferably be done through the customer interface (3b) or through the staff interface (3c) or the manager interface (3a) based on information received from the customer. Access to these interfaces can be achieved via a smartphone, tablet, or computer through a mobile application or the web. The system according to the invention operates through instructions sent by the management program (2) within a server (5) to machines and equipment, requiring no human intervention. The management program (2) that manages the system according to the invention is configured to allow managers to intervene or make administrative changes through user interfaces accessible via a computer, smartphone, or tablet, as needed. With the entry of details such as the design of a product for an order of “N” units, fabric specifications, and desired measurements thereof via the staff interface (3c) or manager interface (3a), the system uses its machine learning-based algorithm to interpret this information and then to automatically calculate all the steps necessary for producing the order. These calculations include, but are not limited to, how many kilograms (or meters) of each fabric type will be needed, what the average width of the rolls of fabric (13) to be ordered will be, and work orders detailing how machines in various production departments will be utilized (for example, the amount of water to be used in the washing machine, the required amount of heat). The program generates a fabric order based on previous order records stored in the database (6) and lists the suppliers from whom the fabric will be ordered. Here, the manager has the option to select a supplier from the list. The system automatically sends the order request to the supplier. The acceptance of said order is processed in the warehouse department (18) as illustrated in a conceptual design in FIG. 3. All the order stages described up to this point are organized by the management panel (3) within the management program (2). The management panel (3) works in integration with the decision engine (4). In the warehouse department (18), the matching of the ordered fabric specifications with the fabrics supplied by the vendor and their allocation to the relevant departments is performed. Each roll of fabric (13) entering the warehouse department (18) is passed through a measurement area. Said measurement area is defined by the boundaries set by at least one sensor (8) capable of distance measurement, and arranged such that at least one camera (7) can optimally capture images of labels (16) on the rolls of fabric (13). The sensors (8) and cameras (7) used to determine the boundaries of the measurement area work in coordination and send data to the server (5) together. As at least one roll of fabric (13) moves through the measurement area, at least one sensor (8) identifies the optimum position for capturing its image, and at least one camera (7) photographs the label (16) on the roll of fabric (13). The data, collected by the camera (7) and sensor (8), is sent to the management program (2) within the server (5) either through a wired connection using the modem (25) located in the department or through a wireless connection system (26) integrated into the relevant machinery and/or equipment, which includes a built-in Wi-Fi adapter or an embedded SIM card (electronic SIM) wherein the transmission occurs over the internet network through either wireless or wired communication channels (such as Ethernet cables), including the use of the wireless connection system (26). The management program (2) analyzes the data received from the camera (7) and sensor (8), using digital image processing techniques and then compares it with corresponding data addressed in the database (6). Thus, information such as which order the relevant roll of fabric (13) belongs to and the type of fabric is automatically determined. If the roll of fabric (13) meets the desired order specifications, its allocation to the appropriate production departments is automatically and instantly arranged; otherwise, the steps for initiating the return procedure are similarly automated and executed in real time. Information regarding these application steps is conveyed to the warehouse staff (18a) through an electronic display (12) via graphical and audible notifications or through handheld terminals (11) carried by the warehouse staff (18a), which can be a smartphone or tablet. The handheld terminals (11) used in the warehouse department (18) can be a tablet, a smartphone, or a barcode scanner, depending on the number and duties of the warehouse staff (18a). For example, a warehouse worker (18a) tasked with scanning fabric labels (16) may utilize a handheld terminal (11) that is a barcode scanner, while another worker (18a) responsible for transportation logistics in the warehouse might opt for a tablet or smartphone as his handheld terminal device (11). In case of a failure in the cameras (7) or sensors (8) within the warehouse department (18 scanned using a handheld terminal (11), that is a barcode scanner, to register them in the system. Additionally, other quality assurance activities in the warehouse department (18), including weighing, sampling, and defect identification, are executed and logged into the system through the staff interface (3c), accessible via a smartphone, tablet, or computer. Following the completion of all tasks in the warehouse, the rolls of fabric (13) are either stacked within the warehouse department (18) or transported to the cutting department (20). sample fabrics (13a) extracted from each fabric roll (13) are reserved for testing purposes. The entire workflow within the warehouse department (18) is monitored and tracked by the warehouse module (4a) operating in harmonious integration with the decision engine (4). In the design department (19) illustrated in the conceptual design in FIG. 4, the design staff (19a) prepares the digital patterns for the related order of “N” units using a modeling program. These digital patterns are drawn on pattern paper (marker paper) according to the width of the roll of fabric (13). The pattern papers produced by the plotting machine (19b) are sent to the cutting department (20). The entire workflow within the design department (19) is monitored and tracked by the design department module (4b), operating in harmonious integration with the decision engine (4). All the processes related to the respective order in the cutting department (20) are automatically communicated to the cutting department staff (20a) by the management program (2) through the relevant machines and equipment, without any need for communication with any staff in the warehouse department (18) or design department (19). This communication may preferably be made through handheld terminals (11) that are smartphones or tablets, an electronic display (12), or if desired, through a printer located in the cutting department (20) for a physical printout. All work orders are communicated to the relevant department by the system without any human intervention. In the cutting department (20), the rolls of fabric (13) arriving from the warehouse department (18) are spread on the cutting table (20b) with the help of a spreading machine (20c). This fabric spreading process is also referred to as “laying out the marker” in the relevant sector. The fabric spreading process (or laying out the marker) is carried out considering the width of the rolls of fabric (13). Here, the fabric with the widest width should be laid at the bottom, and the fabric with the narrowest width should be laid at the top. While these processes are manually performed by the cutting department staff (20a), the management program (2) that interprets the data related to the roll of fabric (13) in the warehouse department (18) automatically calculates which fabric will be subjected to the spreading process in which order, sending this as a work order to the spreading machine (20c). If the roll of fabric (13) loaded on the spreading machine (20c) is in the wrong order, the management program (2) prevents the operation of the spreading machine (20c) and notifies why the operation is incorrect and what should be done in such cases to the cutting department staff (20a) through visual and audible warnings via the electronic display (12) located in the cutting department (20). After the fabric spreading process is completed, the cutting of the spread fabrics (also referred to as the marker) is performed with the help of at least one automatic cutting machine (20d) or at least one semi-automatic cutting machine (20e). Here, if the cutting department staff (20a) creates a situation that endangers their work safety (for example, trying to use the semi-automatic cutting machine (20e) without wearing protective gloves), the system activates warning mechanisms. The warning mechanisms involve alerting the cutting department staff (20a) through visual and audible graphics via at least one electronic display (12) or handheld terminals (11) located in the cutting department (20) and automatically sending the notification about the work safety violation to the relevant units. These notifications are sent as messages or images accessible via email services, through social media platforms (WhatsApp, etc.), or through the manager interface (3a). The system processes all the workflow in the cutting department (20) by analyzing the data received from at least one sensor (8), at least one camera (7), at least one smart wristband (10), at least one smartcard (9), and other machines (as in the warehouse department (18)). Additionally, during the fabric spreading process, defects such as color differences, split and holes on the fabrics are instantly detected by the cutting department module (4c) through image data obtained from at least one camera (7) positioned on the cutting table (20b), using its included image processing algorithms. The data obtained as a result of all the processes between the start and end times of the production stages in the cutting department (20) (such as the weighing/measuring of the leftover fabric and total defective fabric after cutting the spread fabrics, piece data obtained from the labeling machine (20f), etc.) are entered into the system by the cutting department staff (20a) via the staff interface (3c). Thus, the data automatically calculated before the cutting processes are compared with the data obtained as a result of the cutting processes. All these data are transmitted to the decision engine (4) by the cutting department module (4c). The decision engine (4) processes the data received from the cutting department module (4c) along with data of the same category found in the database (6), instantly measuring and reporting the production efficiency in the relevant department. The decision engine (4) performs the same process simultaneously in all other departments (receiving data from the respective module in the department).

The end-to-end management system (1) according to the invention, shown as a conceptual design in FIG. 1, consists of basically a facility that includes various production departments, especially in the readymade clothing industry, and a server (5), which manages the machinery and equipment contained in the facility through a management program (2) therein, without the need for human intervention. Each department within the facility is monitored, directed, and managed by the management program (2) located on the server (5). This management program (2) is characterized by including a module corresponding to each department within the facility, a decision engine (4) that manages these modules, and a management panel (3) that enables users to contact the management program (2) through its interfaces. The invention is based on the principle of planning, monitoring, and directing the production processes conducted in the warehouse department (18), design department (19), cutting department (20), sewing department (21), washing department (22), ironing-packaging department (23), and shipping department (24) of the readymade clothing industry, all in real time and without human intervention. The management program (2) basically consists of a decision engine (4), a management panel (3) and submodules managed by said decision engine (4). The submodules controlled by said decision engine (4) are in the form of warehouse module (4a), design department module (4b), cutting department module (4c), sewing department module (4d), recipe module (4e), iron-pack module (4f), shipping department module (4g). The modules in the management program (2) receive data from all departments which they are contacted and transmit this data to the decision engine (4). The management program (2) exchanges data by contacting all machines and equipment used in the production departments via wired (fiber optic, EtherCat, coaxial cables) or wireless (wifi, NFC, Bluetooth) communication channels and at least one modem (25). Data received from the machine and equipment are processed separately by the decision engine (4) in real time and converted into warnings, instructions and reports. The decision engine (4) stores this information in the database (6), addressing it by the respective module names. The data recorded in said database (6) is continuously processed by the decision engine (4) and the modules are constantly updated by the decision engine (4) to minimize errors occurring in the production processes. Each module can also work on its own, in coordination with only one department, being independent of the system.

The end-to-end management system (1) according to the invention consists of at least one camera (7) which is positioned separately in each production department and is used to monitor all production processes from the warehouse department (18) to the shipping department (24) visually and as location-based, and at least one sensor (8). Monitoring and authorizing the staff involved in said production processes, depending on time and location is carried out by means of at least one smartcard (9) and at least one smart wristband (10). The expression “authorization definition” mentioned here refers to the operation or non-operation of the machine when the smartcard (9) is read into the machine by the management program (2). In addition, thanks to the smartcard (9) and smart wristband (10), it is also determined which staff works on which machine and for what period of time. In each production department, at least one handheld terminal (11) with a smartphone, tablet or barcode reader is used by the relevant staff to enter data into the system. At least one electronic display (12), characterized by containing visual and audio equipment used to guide, give job descriptions and warn the relevant staff, is positioned in said production departments. The real time data obtained from all machines and equipment used in the production processes together with said camera (7), sensor (8), smartcard (9) and smart wristband (10) are recorded to the database (6) by the decision engine (4) in the management program (2).

The relationship between the modules and the management panel is shown in FIG. 2, where the aforementioned management program interprets data obtained from all machinery, hardware, and human resources involved in the production processes through a machine learning-based algorithm, generating real time work plans, work orders, and work reports via a server.

Access to the management panel (3), which is the graphical user interface of said management program (2), is provided via an electronic display (12), handheld terminal (11) or a monitor connected to the server (5). The said server (5) could be a server computer hosting the database (6) or a device such as a personal computer or smartphone with the database (6), included in a cloud server. The management program (2) hosted within the server (5) communicates with machinery, equipment, and human resources through wired and/or wireless communication technologies. Efficiency and quality analyzes of all production operations carried out in production departments are made in real time by the management program (2) and the relevant analyzes are recorded in the database (6) in report format. These reports are preferably accessed directly through the management panel (3), which is the graphical user interface of the management program (2), or said reports are sent by the management program (2) to the relevant persons via e-mail or any application. User interfaces in the management program (2) controlled by the management panel (3) enable the business to be monitored or managed by people. Thus, all production processes can be monitored instantly from any location and every stage of production can be intervened in real time. The management panel (3) has three distinct user interfaces. These are manager interface (3a), customer interface (3b) and staff interface (3c). The manager interface (3a) can be accessed directly via the handheld terminal (11) of the staff defined as administrator or via any smart device (smartphone, tablet, etc.) defined as administrator. Production processes can be intervened manually via the manager interface (3a). The customer interface (3b) can be connected to any smart device (smartphone, tablet, etc.) defined as a customer. Only operations allowed by the manager interface (3a) are performed via the customer interface (3b). The staff interface (3c) can be accessed via handheld terminals (11) located in each production department. Only operations defined in the relevant department can be performed by the staff interface (3c). For example, warehouse staff (18a) have access only to processes related to the warehouse department (18) or can enter data pertaining specifically to the warehouse department (18).

In said end-to-end management system (1), all production data obtained through modules during production processes across all departments—including visual data—are sent in real time to the decision engine (4). These data comprise visual records matched with location information, the instantaneous quantity of fabric used in production, the number of items produced, activities performed by machinery/equipment and staff in real time during the production process, durations of operations, and data entered into the system by staff. Additionally, error reports generated in real time by the module controlling the respective department for detected errors are recorded in the database (6) by the decision engine (4). Such data are obtained through machinery and equipment in the production by the module in the relevant department, while also being inputted into the system through the staff interface (3c) by staff, working in the production processes. These data are then recorded in the database (6) by the decision engine (4). For instance, when an error occurs in a department, the module associated with that department sends an error report to the decision engine (4), detailing the reasons for the errors made during the production process, including time, location, and person/object information on where and in which part of production the errors occurred. The decision engine (4) automatically measures the operational efficiency of the relevant departments using data sent by the modules as well as data previously stored in the database (6). These operational efficiency measurements are calculated both for the entire system and for individual departments. For example, when an error occurs in any department, an error report is sent to the decision engine (4) by the module controlling that department (such as when the recipe module (4e) sends an error report). The decision engine (4) compares the error report generated by the relevant module with past error data stored in the database (6) and sends instructions to the module to either continue operations or stop the process accordingly. If the error falls within acceptable limits, products are sent to the next stage in the relevant production department. On the contrary, if the error exceeds the acceptable limits, the process is halted, and a report is generated on the need to repeat the process or on alternative steps to be taken. Thus, the decision engine (4) can make management decisions on whether to continue or halt stages in the production process without human intervention. The decision engine (4) uses all data obtained from the production processes (error reports, working hours, quantities of products produced, production time, total number of defective products, etc.) to measure the operational efficiency of the enterprise in real time.

In the described end-to-end management system (1), managers can modify the production decisions made by the decision engine (4) by choosing from the options recommended to them via the management panel (3). This ensures that such decisions can be supervised or verified by managers (or individuals authorized to use the manager interface (3a)). When a new order is entered into the system through the manager panel (3a), the decision engine (4) automatically scans the database (6) for past orders that are similar to the new order, generating recommendation reports and presenting these reports to the managers. For instance, the reports may include which workshop can produce the order the fastest through which stages, ranking the workshops with the lowest error rates, and, in case of full capacity in these workshops, offering an optimal ordering that considers the average error range for the entire production process before starting the production operations. The reasons for errors made during the production processes can be automatically assigned by the decision engine (4) as well as entered by staff through the staff interface (3c). All generated reports are relationally addressed and stored separately in the database (6) by the decision engine (4). Real time reports on all production data related to the order are also provided to the ordering customers. The customer interface (3b) allows for tracking in real time which stage the product is in during production and any errors that occur. Requests created through the customer interface (3b) are directly transferred to the manager interface (3a), where managers have the ability to instantly modify the production of an ongoing order based on customer requests. A customer interface (3b) can also be designated as a manager interface (3a) for any given order, allowing the entire process to be managed by the customer, thereby enabling direct tracking and direction by the order owners of multiple orders being produced simultaneously. For example, during the cutting stage, various solutions, such as adding extra fabric or reducing the number of units to compensate for a mistake, can be considered. At this stage, the individual or company placing the order can get involved and make managerial decisions through the customer interface (3b).

The working method of the end-to-end management system (1) shown in the flowchart in FIG. 10 is characterized by the following processes and stages, including:
Positioning of fixed system hardware in the production departments (50),
Association of mobile system hardware with production machinery (51),
Data collection from production departments (52),
Sending work orders to production departments (53).

The aforementioned stages are explained in greater detail below:

Positioning of Fixed System Hardware in the Production Departments (50): This stage involves positioning elements common to all production departments where operations such as storage, design, cutting, sewing, washing, ironing-packaging, or shipping are conducted. At least one camera (7) has been positioned in every production department to carry out fully the followed workflow within that department. The placement of the camera (7) varies according to the production conditions of the respective department. For example, in the cutting department (20), cameras are positioned to mainly view the cutting table (20b). The installation is performed by preferably fixing the movable camera (7) to a wall. At least one sensor (8) has been positioned in each production department to define the boundaries of the working and measuring areas within that department. Like the previously mentioned camera (7), the sensor (8) is positioned differently based on the needs of the respective department. For example, in the warehouse department (18), they are positioned to define the boundaries of the measurement area where the labels (16) on the rolls of fabric (13) are scanned. In the cutting department (20), they are placed in relation to the cutting table (20b) since all production is centered around this cutting table, the sensors (8) are positioned at this point. Electronic displays (12) in each department are positioned so that all staff in the respective production department can easily see them and are related to the workspace. For example, in the sewing department (21), they are hung from the ceiling according to the direction of the workers or positioned on the wall towards which workers turn their faces, ensuring at least one is in place. Each department also has a modem (25). Machinery and equipment in the production departments connect with the decision engine (4), which plans and manages all production operations through a wireless connection system (26) inside them, either directly via the internet network, through the wireless connection system (26), or via wired communication channels with the modem (25) in the respective department.

Association of Mobile System Hardware With Production Machinery (51): This stage encompasses matching the equipment used across all production departments conducting storage, design, cutting, sewing, washing, ironing-packaging, or shipping operations with the staff within the production department. Smartcards (9) carried by each staff member are used to operate the relevant machinery within the production department. Smart wristband (10) worn by each staff member are configured to detect the real time locations of the staff working in the relevant production department and to make voice notifications for directing the staff. Handheld terminals (11), which can be smartphones, tablets, or barcode scanners depending on the needs of the relevant department, are available for every staff member to enter data regarding the production processes, follow work orders, take photos, or use as scanners.

Data Collection From Production Departments (52): This stage defines how data are collected from all machinery and equipment within the production departments where storage, design, cutting, sewing, washing, ironing-packaging, or shipping operations are carried out. The aim is to ensure that all machinery and equipment in all departments transmit their operational data to the server (5) in real time. In every production department, at least one camera (7) sends the real time captured image data directly to the server (5) via the internet network, wireless connection system (26), or wired communication channels through the modem (25) in the relevant department, using either built-in Wi-Fi adapters or electronic SIM chips (electronic SIM) located in the relevant machines and/or equipment. Sensors (8) and smart wristband (10) which utilize the same communication system send location data, electronic displays (12), transmit real time recorded audio data, and handheld terminals (11) send data regarding the production process in real time through the same communication channels to the server (5). Besides these components, the followings are sent to the server (5) following the same logic of data transmission:
At least one plotting machine (19b) in the design department (19) sends real time drawing data,
At least one spreading machine (20c) in the cutting department (20) sends the sequence and total number of rolls of fabric (13) to be spread and the number of layers of fabric spread on the cutting table (20b), and at least one automatic cutting machine (20d) in the cutting department (20) sends data on the status of cutting operations,
At least one sewing machine (21b) in the sewing department (21) sends data on the number of models sewn in real time,
At least one washing machine (22b) in the washing department (22) sends data on the number of models washed, the amount of chemicals used, the quantity of water used, and the temperature of the water,
At least one ironing table (23b) in the ironing-packaging department (23) sends data on the number of models ironed and processed through washing.

Sending Work Orders to Production Departments (53): This stage involves sending work orders to all machinery and equipment in at least one production department where storage, design, cutting, sewing, washing, ironing-packaging, or shipping operations are conducted, using wired connection systems through the modem (25) in the relevant department or directly over the internet via a built-in Wi-Fi adapter or electronic SIM chip (electronic SIM) in the relevant machinery and/or equipment. Said work orders include:
Describing the work process to the staff in the relevant production department through visual graphics and voice notifications on at least one electronic display (12), a smart wristband (10), or a handheld terminal (11), and warning the staff if they create a situation that threatens their safety,
Sending stop, start, and draw instructions to at least one plotting machine (19b) in the design department (19),
Sending stop or start work instructions to at least one spreading machine (20c) and at least one automatic cutting machine (20d) in the cutting department (20),
Sending stop or start work instructions to at least one sewing machine (21b) in the sewing department (21),
Sending stop or start work instructions to at least one washing machine (22b) in the washing department (22), and
Sending stop or start work instructions to at least one ironing table (23b) in the ironing-packaging department (23), characterized by performing these operations in real time.

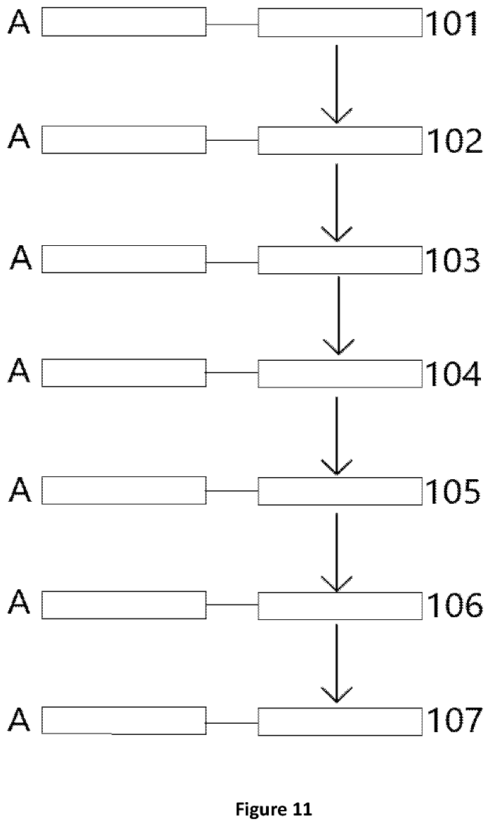

The operational method of the end-to-end management system (1) primarily involves the management program (2) collecting real time data from machinery and equipment used across all production departments, planning all production processes in real time, monitoring them, and reporting. As depicted in the flowchart in FIG. 11, this method is characterized by the following processes and stages:
Planning, monitoring, and reporting process (A),
General management stage of the warehouse department (101),
General management stage of the design department (102),
General management stage of the cutting department (103),
General management stage of the sewing department (104),
General management stage of the washing department (105),
General management stage of the ironing-packaging department (106),
General management stage of the shipping department (107).

The stages listed above are further detailed as follows:
The planning, monitoring, and reporting process (A) is conducted in coordination with the general management stages of the warehouse department (101), of design department (102), of cutting department (103), of sewing department (104), of washing department (105), of ironing-packaging department (106), and of the shipping department (107). Planning is done simultaneously with the continuing production processes in all production departments. All data obtained during production are sent in real time to the decision engine (4) by each module. The decision engine (4) uses data on ongoing production processes in all departments and previous data in the database (6) to send instructions to the module (12) controlling the relevant department on all necessary actions. Thus, the process is planned from start to finish without the need for human intervention. Data on production quantity, location, and time obtained throughout the production process from all staff, machinery, and equipment in the workspace are sent in real time to the decision engine (4) by the relevant module. The decision engine (4) measures the operational efficiency of the relevant department in real time using real time production data from all departments and previous data stored in the database (6). The decision engine (4) activates an audio and/or visual warning mechanism on at least one electronic display (12) and smart wristband (10) in the relevant department to regulate the workflow when any staff does not comply with the planned production process in their department or poses a risk to workplace safety during work. This includes classifying all data obtained from the relevant production department and sending it to the decision engine (4). The decision engine (4) compiles reports on all actions taken in the relevant production department using data from other ongoing processes in the modules and previous data stored in the database (6), and records these reports in the database (6). This reporting process is carried out in real time and/or at the end of the production processes. Access to said reports is provided through interfaces controlled by the management panel (3). These reports are sent to relevant individuals by the decision engine (4) using email services or other communication applications.

General Management Stage of Warehouse Department (101): Each roll of fabric (13) arriving at the warehouse department (18) has at least one label (16) attached by the supplier. This label (16) is detected by at least one camera (7) located in the warehouse department (18). As the roll of fabric (13) passes through an area defined by at least one distance-measuring sensor (8), the camera (7), automatically triggered by the warehouse module (4a), captures a photo of the label (16) on the roll of fabric (13). In case of failure in the camera (7) or sensor (8), labels (16) are preferably read using a handheld terminal (11), which can be a label scanner or a smartphone. The warehouse module (4a) processes the data from the camera (7) or handheld terminal (11) to automatically display on the electronic display (12) which order the incoming roll of fabric (13) belongs to and the total amount of fabric. Procedures related to the fabric, such as weighing, measuring, taking sample fabric (13a), stacking the fabric, returning, or transferring it to the cutting department (20), are described to the warehouse staff (18a) through visual (text or graphic) and audio notifications on the electronic display (12). Planning, monitoring, and reporting process (A) are conducted in coordination with this stage by the decision engine (4).

General Management Stage of Design Department (102): In this stage, the design staff (19a) design readymade products (based on fabric test data) and create models and pattern templates or determine the measurements of the parts that make up the products from existing models. The design department module (4b) uses data entered into the system by the design staff (19a) to generate cutting orders for the cutting department (20). According to the generated cutting orders, the design department module (4b) automatically produces drawing papers through the plotting machine (19b) and sends them to the cutting department (20). All necessary tests, measurement operations, and pattern preparation processes related to sample fabric (13a) are described to the design staff (19a) through visual (text or graphic) and audio notifications on the electronic display (12). Planning, monitoring, and reporting process (A) are conducted in coordination with this stage by the decision engine (4).

General Management Stage of Cutting Department (103): When the label (16) on each roll of fabric (13) arriving at the warehouse department (18) enters the field of view of at least one camera (7), it is detected by said camera (7). The roll of fabric (13) is passed through a measurement area defined by at least one distance-measuring sensor (8) positioned on the spreading machine (20c). During this process, at least one camera (7), automatically triggered by the cutting department module (4c), captures image data from the label (16) on the roll of fabric (13). In case of a malfunction in the camera (7) or sensor (8), the label (16) reading process is preferably carried out using a handheld terminal (11) that is either a label scanner or a smartphone. The cutting department module (4c) processes the data from the camera (7) or handheld terminal (11) to automatically display on the cutting department electronic display (12) which order the incoming roll of fabric (13) belongs to, the sequence in which the spreading machine (20c) will be used, and the number of rolls of fabric (13) required. Procedures to be performed during fabric spreading or cutting, defect control, measurement tracking, taking sample fabric (13a), stacking defective fabrics, applying labels (16) to the cut models (14) using a labeling machine (20f), and transporting the cut models (14) to the sewing department (21) are described in real time to the cutting department staff (20a) through visual (text or graphic) and audio notifications on the electronic display (12) located in the cutting department. Additionally, the cutting department module (4c) automatically calculates the number of products produced and the amount of leftover fabric. Planning, monitoring, and reporting process (A) are conducted in coordination with this stage by the decision engine (4).

General Management Stage of Sewing Department (104): Each cut model (14) coming from the cutting department (20), tagged by the supplier with at least one label (16), is detected by at least one camera (7). The cut models (14) pass through a measurement area defined by at least one distance-measuring sensor (8) positioned on the sewing machine (21b). During this process, at least one camera (7), automatically triggered by the sewing department module (4d), captures the image data of the label (16) on the cut model (14). In case of failure in the camera (7) or sensor (8), the label (16) reading process is preferably conducted using a handheld terminal (11) that can be a label scanner or smartphone. The sewing department module (4d) processes the data from the camera (7) or handheld terminal (11) to automatically display on the sewing department electronic display (12) which specific cut model (14) belongs to which order, the sequence in which it will be sewn on the sewing machine (21b), the number of cut models (14) needed, and the total job count in real time. Procedures required during the sewing operations, such as defect control, measurement tracking, sequencing of parts forming the cut models (14), sewing labels (16) on the sewn models (15), and transporting the sewn models (15) to the washing department (22), are described in real time to the sewing department staff (21a) through visual (text or graphic) and audio notifications on the sewing department electronic display (12). Planning, monitoring, and reporting process (A) is conducted in coordination with this stage by the decision engine (4).

General Management Stage of Washing Department (105): Sewn models (15) coming from the sewing department (21) are washed in batches (groups of models with common characteristics) in the washing machine (22b). Prescribed data and work orders are sent to the washing machine (22b) by the recipe module (4e), automatically activating the washing machine (22b). The data used here include the quantity of chemical substance, duration of the washing process, and the temperature of the water used for washing. The recipe module (4e) processes data from the camera (7) or handheld terminal (11) to automatically display on the electronic display (12) which batch undergoing washing belongs to which order, the operation time of the washing machine (22b), the amount of chemical used, instant temperature data, and the water quantity in the washing machine (22b). Inspection processes required during washing, such as emptying or filling the washing machine (22b) or actions in case of malfunctions, are described in real time to the sewing department staff (21a) through visual (text or graphic) and audio notifications on the washing electronic display (12). Planning, monitoring, and reporting process (A) is conducted in coordination with this stage by the decision engine (4).

General Management Stage of Ironing-Packaging Department (106): Each ironed model (15) that arrives from the Washing Department (22), labeled with a label (16), is identified by at least one camera (7). The ironed models (15) pass through a measurement area determined by at least one sensor (8) positioned on the ironing table (23b). During this process, at least one camera (7), triggered automatically by the Ironing-Packaging Module (4f), captures image data from the label (16) on the ironed model (15). In case of a malfunction in the camera (7) or sensor (8), the label (16) reading process is preferably carried out through a handheld terminal (11) that is either a barcode scanner or a smartphone. The Ironing-Packaging Module (4f), processing data from the camera (7) or handheld terminal (11), automatically displays information on the Ironing-Packaging electronic display (12) regarding which order the ironed model (15) belongs to, the total number of products, and the sequence in which they will be ironed on the ironing table (23b). The processes of ironing, quality control, measurement tracking, placing ironed products into product boxes (17), and transporting them to the Shipping Department (24) are described in real time to the ironing-packaging department staff (23a) through visual (text or graphics) and auditory notifications on the electronic display (12). This stage is coordinated with the Planning, Monitoring, and Reporting Process (A) by the Decision Engine (4).

General Management Stage of Shipping Department (107): Each product box (17) coming from the Ironing-Packaging Department (23), labeled with a label (16), is detected by at least one camera (7). During this process, at least one camera (7), automatically triggered by the shipping department module (4g), captures image data from the labels (16) on the product boxes (17). In the event of a malfunction in the camera (7) or sensor (8), the label (16) reading process is preferably performed using a handheld terminal (11) that is a barcode scanner or a smartphone. The shipping department module (4g), processing data from the camera (7) or handheld terminal (11), automatically projects on the electronic display (12) data about which order each product box (17) belongs to, the total number of boxes, and the sequence in which they will be transported by which carrier (24b) to which shipping vehicle (24c). Based on this data, the shipping department staff (24a) are directed in real time through visual (text or graphics) and auditory notifications on the electronic display (12). This stage is coordinated with the Planning, Monitoring, and Reporting Process (A) by the Decision Engine (4).

The invention is a real-time end-to-end management system (1) that plans, monitors, and directs all production processes-from the entry of at least one roll of fabric (13) into the warehouse department (18) of the ready-to-wear industry, through its modeling in the design department (19), cutting into a cut model (14) in the cutting department (20), sewing into a sewn model (15) in the sewing department (21), washing of the sewn models (15) in the washing department (22), ironing in the ironing-packaging department (23), and finally, placing into product boxes (17) and exiting through the shipping department (24)—by utilizing data from at least one camera (7), at least one sensor (8), at least one smart card (9), a smart wristband (10), at least one electronic screen (12), at least one handheld terminal (11), and other machines and equipment positioned in each production department, while also sending work orders to all mentioned machines and equipment along with human resources, and the system is characterized by comprising:
at least one server (5) comprising a management program (2) made up of all modules including a decision engine (4) and a management panel (3), from the warehouse department (18) to the shipping department (24), that plans the production processes conducted in all production departments by receiving and sending data to and from the machines and equipment stationed in those departments, monitors the work processes in these production departments in real time, directs the production processes by sending work orders to all said machines, equipment, and human resources involved in these production processes, resolves problems occurring in these production processes in real time, and a database (6) that records all the mentioned data in real time;
at least one electronic display (12), used as a warning mechanism in case of a safety threat and to describe the processes that need to be implemented by the relevant personnel in the form of visual or auditory commands, automatically and in real time controlled by the decision engine (4) that operates integrated with the warehouse module (4a), pattern-making module (4b), cutting module (4c), sewing module (4d), recipe module (4e), and ironing-packaging module (4f), planning, managing, and monitoring production processes conducted in all production departments, at least one camera (7) to verify if the relevant personnel have correctly implemented the notifications, at least one smart wristband (10) and at least one sensor (8) used to track the movements of the personnel in the workspace based on their location, and at least one smart card (9) used for real-time identity verification of the relevant personnel and for authorization verification to operate the machines used in production.
at least one camera (7) or handheld terminal (11)—located in the warehouse department (18) and automatically controlled in real-time by the warehouse module (4a)—for classifying at least one roll of fabric (13) (such as fabric type, order number, etc.) by capturing image data from the label (16) on said roll of fabric (13), and at least one sensor (8) to detect and track the position and quantity of said rolls of fabric (13) in real time,
at least one camera (7)—located in the design department (19) and automatically controlled in real-time by the design department module (4b)—for monitoring the tests conducted on sample fabrics (13a) by design department personnel (19a) and the process of creating model patterns, and at least one plotting machine (19b) that generates cutting orders in real-time for the cutting department (20),
at least one camera (7) or hand-held terminal (11)—located in the cutting department (20) and controlled in real-time by the cutting department module (4c)—that captures image data from the label (16) on at least one roll of fabric (13) to determine the order of laying out the fabric by the spreading machine (20c) on the cutting table (20b), at least one camera (7), sensor (8), or spreading machine (20c) used to calculate the number of layers of fabric laid on the cutting table (20b) and the instant count of product pieces, and at least one sensor (8), camera (7), and an automatic cutting machine (20d) used to compute and monitor the total number of products and the amount of fabric waste generated during the cutting process,
at least one camera (7) or hand-held terminal (11)—located in the sewing department (21) and controlled in real-time by the sewing department module (4d)—that captures image data from labels (16) on cut models (14) to determine the order in which the parts of at least one cut model (14) will be sewn on at least one sewing machine (21b), and at least one sensor (8), camera (7), or sewing machine (21b) used to instantly detect and track the number of cut models (14) to be sewn and the completed sewn models (15),
at least one camera (7) or hand-held terminal (11)—located in the washing department (22) and automatically and real-time controlled by the recipe module (4e)—that captures image data from the label (16) on at least one sewn model (15) to determine the order of washing in the washing machine (22b), at least one sensor (8) and at least one camera (7) to detect and monitor the number of sewn models (15) to be washed in real-time, and at least one washing machine (22b) to adjust the amount of water and chemicals used, the duration of the washing process, and the washing temperature,
at least one ironing table (23b)—positioned in the ironing and packaging department (23) and automatically and real-time controlled by the ironing and packaging module (4f)—to adjust the amount of water used, ironing time, and ironing temperature for the ironing process; at least one camera (7) or hand-held terminal (11) that captures image data from the label (16) on at least one washed sewn model (15) to determine the order of ironing on said ironing table (23b); and at least one sensor (8) and at least one camera (7) to detect and monitor the number of sewn models (15) to be ironed and determine which product box (17) the related product will be placed in.
at least one camera (7) or handheld terminal (11)—positioned in the shipping department (24) and automatically and real-time controlled by the shipping department module (4g)—that captures image data from the label (16) on at least one product box (17) to determine the order of transport by at least one carrier (24b) to at least one shipping vehicle (24c), and at least one sensor (8) and at least one camera (7) to detect and monitor in real-time the number of product boxes (17) and which product box (17) is to be transported by which carrier (24b) to which shipping vehicle (24c).
at least one handheld terminal (11) utilized by managers, which is a smartphone, tablet, or computer, accessible in real time via the manager interface (3a)—that is a user interface of the management panel (3)—which enables monitoring of work processes in all production departments through cameras (7), viewing work reports created by the decision engine (4) related to work processes, data entry into the program, and written and verbal communication with staff or customers.
a smartphone, tablet, or computer, accessible in real time via the customer interface (3b)—that is another user interface of the management panel (3)—which enables real-time monitoring of ongoing work processes in all production departments via cameras (7), viewing of work reports generated by the decision engine (4) related to work processes, and written and verbal communication with managers,
a handheld terminal (11) utilized by the staff, which is a smartphone, tablet, or computer, accessible in real time via the staff interface (3c)—that is another user interface of the management panel (3)—allowing only staff working in production departments to enter quantity and error information into the system, view work reports generated by the decision engine (4), and communicate with managers both in writing and verbally.

In the end-to-end management system (1), each production department commonly utilizes at least one camera (7) for capturing images of labels (16) or employees. At least one sensor (8), configured according to the needs of the production department in which it is used, is positioned in all departments. The identification of an employee in real time and the authorization necessary to operate any machine is facilitated through at least one smartcard (9). The real time location of staff is determined by the integrated operation of smart wristband (10) and cameras (7). Each department contains at least one handheld terminal (11) serving different functions, which could be a barcode scanner, a tablet, or a smartphone depending on the department's needs. Furthermore, each production department houses at least one electronic display (12), configured according to the specific requirements of the department. These configurations vary based on the physical conditions of the respective department. For example, touch-sensitive electronic displays (12) are preferred in areas where managers are present, while water-resistant electronic displays (12) are chosen in the ironing-packaging department (23) due to the humidity level. Different sizes of electronic displays (12) can be found across various departments.

FIG. 3 conceptually illustrates the production process conducted in the warehouse department (18), managed and directed by the management program (2), involving human and machine elements. The warehouse department (18) managed by the end-to-end management system (1) is the department where fabrics used in production are introduced, sorted, and stacked. These fabrics, preferably obtained through weaving or knitting surface methods, are typically wound on rolls made of wood, cardboard, or composite material in the form of fabric rolls. The warehouse department (18) is characterized in that it comprises at least one roll of fabric (13), at least one label (16), and at least one warehouse staff (18a) in addition to the common elements used in other departments. The warehouse module (4a) in the management program (2) controls the warehouse department (18), primarily managing all records of fabric in and outflows and monitoring stock conditions. More specifically, it oversees processes such as the transfer of fabrics to multiple warehouses, return processes, the quantity of fabric per quality, total stock status, and calculation of fabric data for ongoing orders. The warehouse module (4a) performs these tasks by receiving and sending data to the machines and equipment located in the warehouse department (18), with this data flow facilitated by the decision engine (4). The warehouse module (4a) includes at least one camera (7) to capture image data from the label (16) on the roll of fabric (13) for real time classification, at least one sensor (8) and at least one camera (7) to detect and track the location and count of the roll of fabric (13) in real time. An electronic display (12), configured for the warehouse department (18), describes the processes that need to be applied to at least one roll of fabric (13) to the warehouse staff (18a) in real time through visual or auditory commands. At least one camera (7), at least one smart wristband (10), or at least one sensor (8) work together to verify if the warehouse staff (18a) correctly implement the notifications in real time.

FIG. 4 conceptually illustrates the production process conducted in the design department (19), managed and directed by the management program (2), involving human and machinery elements. The design department (19) within the end-to-end management system (1) is where readymade clothing products are designed based on fabric test data, patterns and model templates are created, or measurements for parts constituting products from pre-existing models are determined, and cutting orders for the cutting department (20) are generated. The design department (19) is characterized in that it comprises at least one sample fabric (13a), at least one label (16), at least one design department staff (19a), and at least one plotting machine (19b) in addition to the common elements used in other departments. The design department (19) is controlled by the design department module (4b) in the management program (2). This design department module (4b) designs readymade clothing products based on tests (like tensile tests) performed on sample fabrics (13a) from the warehouse module (4a), creates patterns for models, determines measurements for parts constituting products from pre-existing models, and generates cutting orders for the cutting department (20). The design department module (4b) performs these tasks by receiving data from machines and equipment located in the design department (19), in addition to data obtained from the warehouse module (4a), with the data flow facilitated by the decision engine (4). The design department module (4b) operates integrated with at least one design department electronic display (12) to describe the processes to be applied by the design staff (19a) in real time through visual or auditory commands, at least one camera (7), at least one smart wristband (10), or at least one sensor (8) to verify if the design staff (19a) correctly implement the notifications in real time, and at least one smartcard (9) for identity verification of the design staff (19a) and to operate the plotting machine (19b).

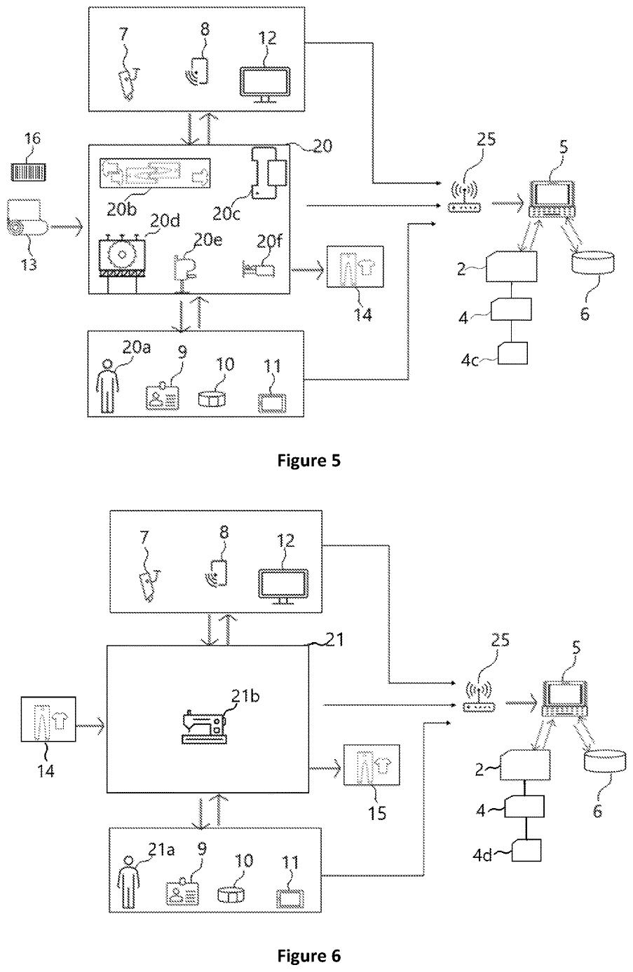

FIG. 5 conceptually shows the production process conducted in the cutting department (20), managed and directed by the management program (2), involving human and machinery elements. The cutting department (20) within the end-to-end management system (1) is where rolls of fabric (13) coming from the warehouse department (18) are cut according to specific models to prepare them for sewing. The cutting department (20) includes, along with common machinery and equipment found in all production departments, at least one cutting table (20b), at least one spreading machine (20c), at least one automatic cutting machine (20d), at least one semi-automatic cutting machine (20e), and at least one labeling machine (20f). All machinery and equipment in the cutting department (20) are controlled by the cutting department module (4c) found in the management program (2). This cutting department module (4c) primarily manages and controls all processes from the spreading of rolls of fabric (13) on the cutting table (20b) to the transformation into ready-to-sew cut models (14). The cutting department module (4c) performs these tasks by receiving data from the warehouse module (4a) and the design department module (4b), as well as from machinery and equipment located in the cutting department (20), with the data flow facilitated by the decision engine (4). The cutting department module (4c) includes at least one camera (7) that captures image data from labels (16) on rolls of fabric (13) to determine the real time sequence of spreading these rolls on the cutting table (20b) via the spreading machine (20c), and at least one handheld terminal (11), which could be a smartphone, tablet, or barcode reader designated for cutting department staff (20a). To detect and monitor the number of rolls of fabric (13) to be used in real time, at least one sensor (8) and at least one camera (7) work together in an integrated manner. Processes to be applied by the cutting department staff (20a), described in real time through visual or auditory commands, are facilitated through at least one electronic display (12) configured for the cutting department (20). At least one camera (7), at least one smart wristband (10), and at least one sensor (8) work together in an integrated manner to verify if the cutting department staff (20a) correctly implement the notifications sent through the electronic display (12) in real time.

FIG. 6 conceptually displays the production process conducted in the sewing department (21), managed and directed by the management program (2), involving human and machinery elements. The sewing department (21) within the end-to-end management system (1) is where cut models (14) received from the cutting department (20) are sewn and prepared for washing. The sewing department (21) includes common machinery and equipment found in all production departments, along with at least one cut model (14), at least one label (16), at least one sewing department staff (21a), and at least one sewing machine (21b). The sewing department (21) is controlled by the sewing department module (4d) found in the management program (2). This sewing department module (4d) oversees and controls all processes from the sewing of cut models (14) with sewing machines (21b) and other equipment until they become sewn models (15). The sewing department module (4d) performs these tasks with data obtained from the warehouse module (4a), the design department module (4b), and the cutting department module (4c), in addition to data from machinery and equipment located in the sewing department (21), with the workflow facilitated by the decision engine (4). To determine the real time sequence for sewing cut model (14) parts on at least one sewing machine (21b), image data is captured from labels (16) on the cut models (14) by at least one camera (7) or handheld terminal (11). To detect and monitor the number of cut models (14) to be sewn in real time, at least one sensor (8) and at least one camera (7) are utilized. Processes to be applied by sewing department staff (21a) are instructed through visual or auditory commands via at least one electronic display (12) configured for the sewing department (21). The correct implementation of notifications by sewing department staff (21a) is determined in real time by the relevant module using data from at least one camera (7), at least one smart wristband (10), or at least one sensor (8).

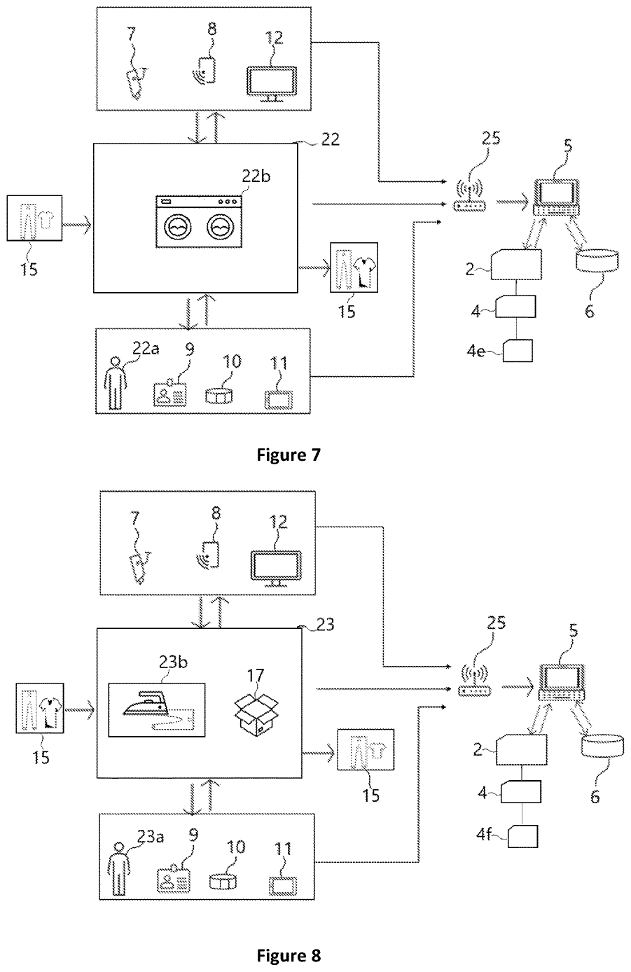

FIG. 7 conceptually shows the production process in the washing department (22), directed and managed by the management program (2), involving human and machinery elements. The washing department (22) within the end-to-end management system (1) prepares sewn models (15) received from the sewing department (21) for the quality control stage by washing them. This department is also referred to as the recipe department. The washing department (22) includes, along with commonly found machinery and equipment in all production departments, at least one sewn model (15), at least one label (16), at least one washing department staff (22a), and at least one washing machine (22b). It is controlled by the recipe module (4e) found in the management program (2). The recipe module (4e) generally oversees and controls all processes from washing the sewn models (15) in the washing machine (22b) until they are sent to the ironing-packaging department (23). This module performs these tasks with data from the warehouse module (4a), design department module (4b), cutting department module (4c), and sewing department module (4d), in addition to data from machinery and equipment located in the washing department (22), facilitated by the data flow from the decision engine (4). The recipe module (4e) controls at least one washing machine (22b) to set the water amount, washing duration, and temperature for the washing process. To determine the washing sequence for at least one sewn model (15) in real time, image data is captured from the label (16) on the sewn model (15) by at least one camera (7) or handheld terminal (11). At least one sensor (8) and at least one camera (7) are utilized to detect and monitor the number of sewn models (15) to be washed in real time. Processes to be applied by washing department staff (22a) are instructed through visual or auditory commands in real time via at least one washing electronic display (12). The correct implementation of notifications by washing department staff (22a) is determined in real time by the relevant module using data from at least one camera (7), at least one smart wristband (10), or at least one sensor (8).

FIG. 8 conceptually illustrates the production process in the ironing-packaging department (23), directed and managed by the management program (2), incorporating human and machine elements. In the end-to-end management system (1), the ironing-packaging department (23) is where products are ironed, undergo final checks, and are prepared for dispatch (including packaging and boxing) to the shipping department (24). Alongside commonly found machinery and equipment in all production sections, the ironing-packaging department (23) includes at least one sewn model (15) that has undergone washing, at least one label (16), at least one ironing-packaging staff (23a), at least one ironing table (23b), and at least one product box (17). It is controlled by the ironing-packaging module (4f) found in the management program (2). The ironing-packaging module (4f) generally oversees and controls all processes from ironing and packaging washed sewn models (15) until they are sent to the shipping department (24). It performs these tasks with data from the warehouse module (4a), design department module (4b), cutting department module (4c), sewing department module (4d), and recipe module (4e), in addition to data from all machinery and equipment located in the ironing-packaging department (23), facilitated by the data flow from the decision engine (4). The ironing-packaging module (4f) includes at least one ironing table (23b) to set the water amount, ironing duration, and ironing temperature. To determine the ironing sequence for at least one sewn model (15) in real time, image data is captured from the label (16) on the sewn model (15) by at least one camera (7) or handheld terminal (11). At least one sensor (8) and at least one camera (7), managed by the ironing-packaging module (4f), are utilized to detect and monitor the number of sewn models (15) to be ironed and which product will be placed in which product box (17) in real time. Processes to be applied by ironing-packaging department staff (23a) are instructed through visual or auditory commands in real time via at least one electronic display (12). The correct implementation of notifications by ironing-packaging department staff (23a) is determined in real time by the relevant module using data from at least one camera (7), at least one smart wristband (10), or at least one sensor (8).

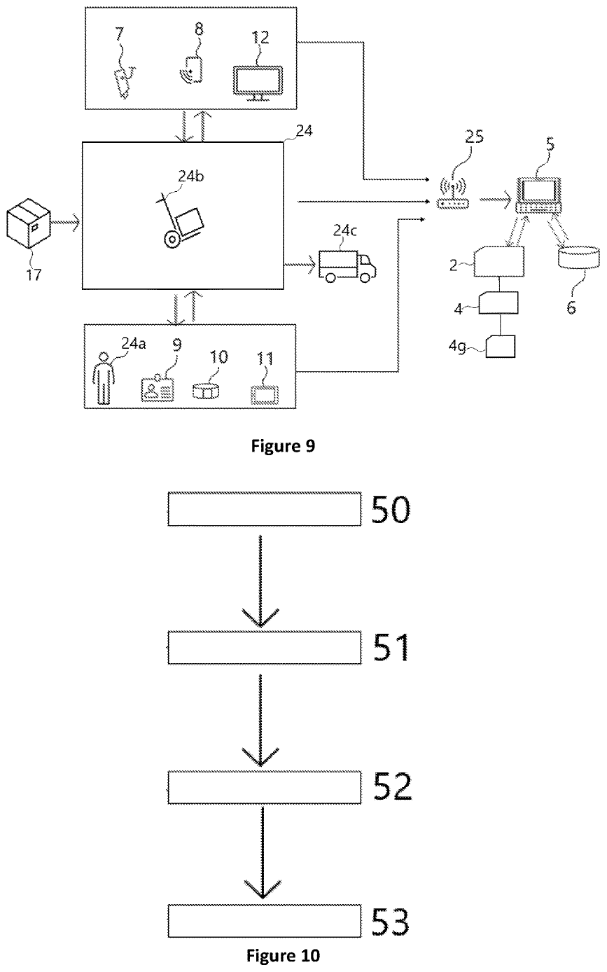

FIG. 9 conceptually illustrates the production process in the shipping department (24), directed and managed by the management program (2), incorporating human and machine elements. In the end-to-end management system (1), the Shipping department (24) is where packaged products from the ironing-packaging department (23) are dispatched outside the facility for delivery to various sales points. The Shipping department (24) includes, like all other production sections, at least one product box (17), at least one shipping department staff (24a), at least one electronic display (12), at least one carrier (24b), and at least one shipping vehicle (24c). It is controlled by the shipping department module (4g) within the management program (2). The shipping department module (4g) generally oversees and controls all operations from final checks of products coming from the ironing-packaging department (23) until they are sent from the facility. It performs these tasks with data from the ironing-packaging module (4f) and all machinery and equipment located in the Shipping department (24), facilitated by the data flow from the decision engine (4). The shipping department module (4g) uses at least one camera (7) or handheld terminal (11) to capture image data from the label (16) on the product box (17) to determine in real time the sequence in which each product box (17) will be loaded onto the shipping vehicle (24c) via at least one carrier (24b). At least one sensor (8) and at least one camera (7) are used to detect and monitor the number of product boxes (17) to be transported, and which product box (17) will be transported by which carrier (24b) to which shipping vehicle (24c). Processes to be applied by the shipping department staff (24a) are instructed through visual or auditory commands in real time via at least one electronic display (12). The correct implementation of notifications by the shipping department staff (24a) is determined in real time by the relevant module using data from at least one camera (7), at least one smart wristband (10), or at least one sensor (8).

The specification describes the invention through a specific application not to limit the scope but to facilitate the understanding of the invention. It is evident that various modifications or variations can be made within the technical scope of the described invention using the claims, specification, and drawings for a person skilled in the art. It is intended that the invention be fully defined by the claims and that various modifications or variations of the invention fall within the scope of the present invention.

### Application of the Invention in Industry

The end-to-end management system (1) according to of the invention is specifically applicable to facilities in the readymade clothing industry that require automated planning, production, and tracking systems and include departments such as warehouse, design, cutting, sewing, washing, ironing-packaging, and shipping. However, although described through the readymade clothing industry, the system can also be adapted to business organizations in different areas of the industry with different production techniques.

1. An integrated electronic system for planning a production process in real time, from a warehouse department to a shipping department in the textile industry, by means of data obtained through machines and equipment used during the production processes; and of intervening in said production processes in real time by sending data to all said machines and equipment, thereby managing said production in real time, and thus characterized by an end-to-end management system which comprises:
at least one production department where storage, design, cutting, sewing, washing, ironing-packaging, or shipping operations are conducted;
machines and equipment located in said at least one production department for planning and managing production processes in real time;
a decision engine for intervening in said production processes in real time, that interprets data related to the production processes entered into the system automatically from machines and equipment located in all production departments and/or by the relevant staff through the equipment, sends work orders to all machines and equipment together with the human resources involved in said production processes, and directs the production processes; and
a server comprising said decision engine and a database enabling all said machines and equipment to exchange data in real time with the decision engine directly through the internet network via a wireless connection system, or through a modem located in the relevant department of the wireless connection system or wired communication channels.

2. The end-to-end management system of claim 1, comprising: ;
at least one camera located in each production department, capable of rotating 360 degrees and transmitting the visual data it obtains to another device or system wirelessly or through wired connections;
at least one sensor located in each production department, capable of distance, temperature, sound, or color recognition;
at least one smartcard used by staff working in each production department, equipped with NFC or RFID technology;
at least one smart wristband, such as a GPS wristband or smartwatch, used by staff working in each production department;
at least one handheld terminal used in each production department, such as a smartphone, tablet, or barcode reader;
at least one electronic display comprising a microphone and speaker located in each production department;
a management panel used for real time monitoring of said production departments, entering data into the system, and viewing production reports, accessible via a computer, smartphone, or tablet, containing user interfaces;
wherein the decision engine tracks work processes in the production departments through modules contained in cameras, sensors, smartcards, smart wristbands, handheld terminals, electronic displays, and other machines located in all mentioned production departments, and directs the production processes by sending work orders to all machines and equipment together with the human resources involved in said production processes; and
wherein all data obtained from said production departments are recorded in real time by the decision engine on the server.

3. The end-to-end management system of claim 1, characterized by comprising at least one camera for the classification of at least one roll of fabric, that receives image data from a label on said roll of fabric, and at least one sensor that detects the location data of said rolls of fabric, automatically managed by a warehouse module which reports the work process in the warehouse department to the decision engine in real time.

4. The end-to-end management system of claim 1, comprising at least one camera that follows tests conducted on sample fabrics by design staff and the processes of creating pattern models, and at least one plotting machine that generates cutting orders in real time for a cutting department, automatically managed by a design department module which reports the work process in the design department to the decision engine in real time.

5. The end-to-end management system of claim 1, comprising at least one camera or at least one handheld terminal that receives image data from a label on a roll of fabric to determine a laying order of at least one roll of fabric to be laid on a cutting table by a spreading machine; and at least one camera and sensor or at least one spreading machine used to calculate the number of fabric layers and the instant count of products laid on said cutting table, and at least one sensor, at least one camera, and at least one automatic cutting machine used to calculate and track the total number of products and the amount of leftover fabric generated during the cutting process, automatically managed by a cutting department module which reports the work process in the cutting department to the decision engine in real time.

6. The end-to-end management system of claim 1, comprising at least one camera or handheld terminal that receives image data from a label on a cut model to determine a sewing order of at least one cut model to be sewn in at least one sewing machine; at least one sensor, at least one camera, or at least one sewing machine for the instant detection and tracking of the number of said cut models to be sewn and the number of sewn models, automatically managed by a sewing department module which reports the work process in the sewing department to the decision engine in real time.

7. The end-to-end management system of claim 1, comprising at least one camera or handheld terminal that receives image data from a label on a sewn model to determine the washing order for at least one sewn model to be washed in a washing machine; at least one sensor and at least one camera for the real time detection and tracking of the number of sewn models to be washed, and at least one washing machine for adjusting the amount of water, amount of chemicals, washing time, and washing temperature used in the washing process, automatically managed by a recipe module which reports the work process in the washing department to the decision engine in real time.

8. The end-to-end management system of claim 1, comprising at least one ironing table for adjusting the amount of water, ironing time, and iron temperature to be used in an ironing process; at least one camera and at least one terminal that receives image data from a label on a washed and sewn model to determine the ironing order of at least one sewn model to be ironed on said at least one ironing table, and at least one sensor and at least one camera for the real time detection and tracking of the number of sewn models to be ironed and which iron package the related product will be placed in, automatically managed by an ironing-packaging module which reports the work process in the ironing-packaging department to the decision engine in real time.

9. The end-to-end management system of claim 1, comprising at least one camera or at least one terminal that receives image data from a label on a product box to determine the transport order for at least one product box to be transported by at least one carrier with a shipping vehicle; at least one sensor and at least one camera for the real time detection and tracking of the number of product boxes and which product box will be transported by which carrier to which shipping vehicle, automatically managed by a shipping department module which reports the work process in the shipping department to the decision engine in real time.

10. The end-to-end management system of claim 1, comprising at least one handheld terminal used by managers, which is a smartphone, tablet, or computer having a user interface, the manager interface, accessible in real time by a management panel, allowing for the tracking of work processes in all production departments via cameras, viewing of work reports generated by the decision engine related to the work processes, inputting data into the program, and facilitating written and verbal communication with staff or customers.

11. The end-to-end management system of claim 1, comprising a smartphone, tablet, or computer that includes a customer interface, a user interface accessible in real time by a management panel, allowing for the real time tracking of ongoing work processes in all production departments via cameras, viewing of work reports generated by the decision engine related to the work processes, and facilitating written and verbal communication with managers.

12. The end-to-end management system of claim 1, comprising a handheld terminal used by staff, which is a smartphone, tablet, or computer, having a user interface, a staff interface, accessible in real time by the management panel, which allows for the input of quantity information and error information related to ongoing work processes in production departments operated solely by staff, viewing of work reports generated by the decision engine, and facilitating written and verbal communication with managers.

13. A working method for the system components structured to enable real time direction of production, according to claim 1, comprising the following stages:
positioning fixed system hardware in the production departments;
associating mobile system hardware with production machines;
collecting data from production departments; and
sending work orders to production departments.

14. The working method according to claim 13, wherein the stage of positioning fixed system hardware in the production departments comprises
positioning the followings in at least one production department where storage, modeling, cutting, sewing, washing, ironing-packaging, or shipping operations are conducted;
positioning at least one camera in the relevant production department to fully display the workflow in that department;
positioning at least one sensor in the relevant production department to define the boundaries of working and measuring areas;
positioning at least one electronic display in the relevant production department to enable alerting all workers with graphical images and audible notifications and to collect sound data from the workspace; and
positioning at least one modem in the relevant production department to allow uninterrupted communication with all machines and equipment.

15. The working method of claim 13, wherein the stage of associating mobile system hardware with production machines comprises:
associating the followings, with the staff in at least one production department, where storage, modeling, cutting, sewing, washing, ironing-packaging, or shipping operations are conducted;
associating at least one smartcard used to operate the relevant machine in the relevant production department;
configuring at least one smart wristband in the relevant production department to perform instant location detection and provide audible notifications; and
associating at least one handheld terminal used in the relevant production department for data entry related to work processes, tracking work orders, taking photos, or scanning.

16. The working method of claim 1, wherein the data collection stage from production departments comprises:
sending the following data, in real time directly to the server via the internet or through the wireless connection system or wired communication channels via the modem, included in the related all machinery and equipment, thanks to their integrated wireless connection system, located in at least one production department where storage, modeling, cutting, sewing, washing, ironing-packaging, or shipping operations are conducted;
sending real time image data captured by at least one camera in the relevant production department;
sending real time location data detected by at least one sensor in the relevant production department;
sending real time sound data recorded via a microphone by at least one electronic display in the relevant production department;
sending real time location information data from at least one smart wristband in the relevant production department;
sending real time data related to the work process recorded in at least one handheld terminal in the relevant production department;
sending real time drawing data contained by at least one plotting machine in the design department;
sending the sequence of spreading and the total number of rolls of fabric and the number of fabric layers spread on the cutting table by at least one spreading machine in the cutting department along with cutting operation status data by at least one automatic cutting machine;
sending real time data on the number of sewn models by at least one sewing machine in the sewing department;
sending real time data on the number of sewn models washed, the amount of chemicals used, the amount of water used, and the water temperature by at least one washing machine in the washing department; and
sending real time data on the number of sewn models subjected to the ironing process and passed through the washing process by at least one ironing table in the ironing-packaging department

17. The working method of claim 1, wherein the stage of sending work orders to production departments comprises performing the following stages in real time:
the processing of real time data sent through the integrated wireless connection system of all machinery and equipment in at least one production department involved in storage, modeling, cutting, sewing, washing, ironing-packaging, or shipping operations, this data being transmitted directly via the internet or through the wireless connection system or wired communication channels to the server via the modem in the relevant department, and the decision engine, utilizing the same communication channels, then sends work orders to the relevant modules in the related production departments, based on this data processed by an artificial intelligence algorithm that plans, directs, and intervenes in the production process;
describing the work process through visual graphics and vocal notifications on at least one electronic display, at least one smart wristband, or at least one handheld terminal in the relevant production department, and warning the relevant staff in case of a situation threatening work safety;
sending stop, work, and drawing instructions to at least one plotting machine in the design room department;
sending stop or work instructions to at least one spreading machine and at least one automatic cutting machine in the cutting department;
sending stop or work instructions to at least one sewing machine in the sewing department;
sending stop or work instructions to at least one washing machine in the washing department; and
sending stop or work instructions to at least one ironing table in the ironing-packaging department.

18. An end-to-end management system as an electronic system capable of planning, monitoring, directing, and intervening in real time in a production process as executed by machines, and comprising:
at least one production department where production processes are conducted with the assistance of minimal machinery and equipment and at least one staff member;
machinery and equipment located in said production departments for planning and managing the production processes in real time;
a decision engine for intervening in said production processes in real time, that interprets data related to the production processes entered into the system automatically from machines and equipment located in all production departments and/or by the relevant staff through the equipment, sends work orders to all machines and equipment together with the human resources involved in said production processes, and directs the production processes; and
a server, comprising said decision engine and a database, enabling all said machines and equipment to exchange data in real time with the decision engine directly through the internet network via a wireless connection system, or through a modem located in the relevant department of the wireless connection system or wired communication channels.
